(19) United States
(12) Patent Application Publication
(10) Pub. No.: US 2025/0304154 A1
(43) Pub. Date: Oct. 2, 2025

(54) CONTROL DEVICE

(71) Applicant: HONDA MOTOR CO., LTD., Tokyo (JP)

(72) Inventor: Yoshihiro ONIWA, Tokyo (JP)

(73) Assignee: HONDA MOTOR CO., LTD., Tokyo (JP)

(21) Appl. No.: 19/063,342

(22) Filed: Feb. 26, 2025

(30) Foreign Application Priority Data
Mar. 29, 2024 (JP) 2024-055646

(51) Int. Cl. B62D 6/00

(52) U.S. Cl. CPC B62D 6/00

(57) ABSTRACT

A control device is configured to control a vehicle that allows for steering a steering device by a driver and steering the steering device by the control device. The control device comprises circuitry configured to: acquire a steering torque, a steering angle velocity, and a steering angle deviation which is a difference between an instructed steering angle by the control device and an actual steering angle of the steering device; and determine, when the steering device is steered by the control device, whether a steering state is a steering state intended by the driver or a steering state intended by the control device, based on the steering torque, the steering angle velocity, and the steering angle deviation.

### CROSS-REFERENCE TO RELATED APPLICATIONS

This application is based on and claims priority under 35 USC 119 from Japanese Patent Application No. 2024-055646 filed on Mar. 29, 2024, the contents of which are incorporated herein by reference.

### TECHNICAL FIELD

The present disclosure relates to a control device.

### BACKGROUND ART

In recent years, active efforts have been made to provide access to a sustainable transportation system in consideration of vulnerable traffic participants. As one of these efforts, research and development on driving assistance techniques and preventive safety techniques for vehicles such as automobiles have been made in order to further improve safety and convenience of traffic.

For example, in the related art, an electric power steering apparatus is known that assists steering torque so as to perform steering intended by a driver (for example, Japanese Patent Application Laid-Open Publication No. 2019-006393A).

However, in recent years, a control device or a system that performs driving assistance may perform steering (for example, steering by driving assistance that performs lane keeping), and in such a case, it may be insufficient to control a vehicle only in consideration of steering of the driver.

Therefore, it is desirable to execute steering control in consideration of steering by driving assistance (steering of a control device or a system that performs driving assistance) in addition to steering by a driver.

The present disclosure provides a control device capable of executing steering control in consideration of steering by a driver and steering by driving assistance.

### SUMMARY

An aspect of the present disclosure relates to a control device configured to control a vehicle that allows for steering a steering device by a driver and steering the steering device by the control device,
in which the control device includes circuitry configured to:
acquire a steering torque, a steering angle velocity, and a steering angle deviation which is a difference between an instructed steering angle by the control device and an actual steering angle of the steering device; and
determine, when the steering device is steered by the control device, whether a steering state is a steering state intended by the driver or a steering state intended by the control device, based on the steering torque, the steering angle velocity, and the steering angle deviation.

According to the present disclosure, it is possible to execute steering control based on steering by a driver and steering by driving assistance. Further, it is possible to improve traffic safety and contribute to development of a sustainable transportation system.

### BRIEF DESCRIPTION OF DRAWINGS

FIG. 1 is a block diagram showing a schematic configuration of a vehicle 1 on which a control device 30 according to an embodiment is mounted.

FIG. 2 is a diagram showing a steering state of a driver.

FIG. 3 is a diagram showing a steering state of the control device 30.

FIG. 4 is a diagram showing an example of a situation in which the vehicle 1 is not in an intended steering state.

FIG. 5 is a flowchart (part 1) showing an example of processing executed by the control device 30 according to the embodiment.

FIG. 6 is a flowchart (part 2) showing an example of the processing executed by the control device 30 according to the embodiment.

FIG. 7 is a flowchart (part 3) showing an example of the processing executed by the control device 30 according to the embodiment.

### DESCRIPTION OF EMBODIMENTS

Hereinafter, an embodiment of a vehicle control device according to the present disclosure will be described with reference to the drawings. The following embodiment does not limit the present disclosure, and not all of elements described in the following embodiment are necessary to the present disclosure. Two or more elements described in the following embodiment may be freely combined without departing from the gist of the present disclosure. Hereinafter, the same or similar elements are denoted by the same or similar reference signs, and a description thereof may be omitted or simplified.

Vehicle Equipped with Control Device

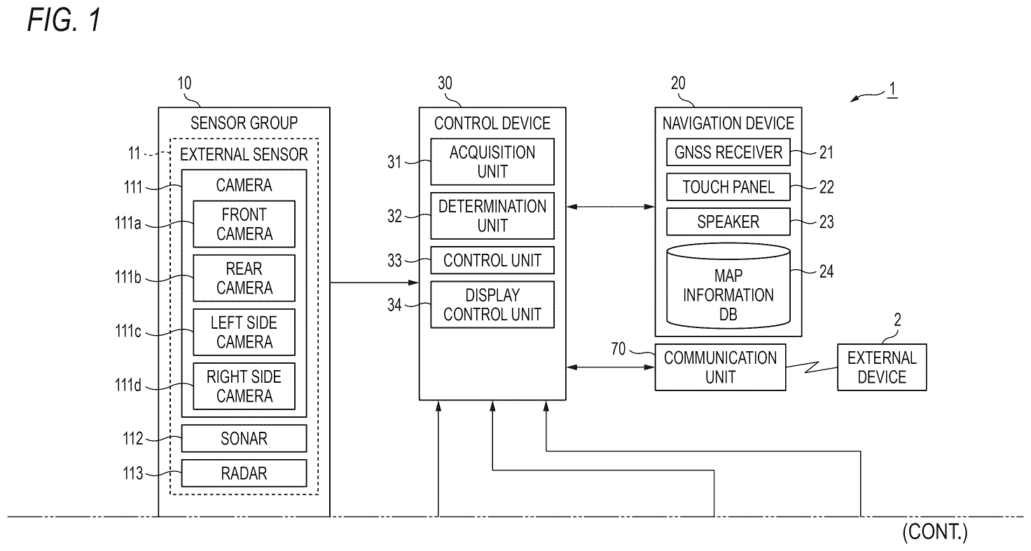

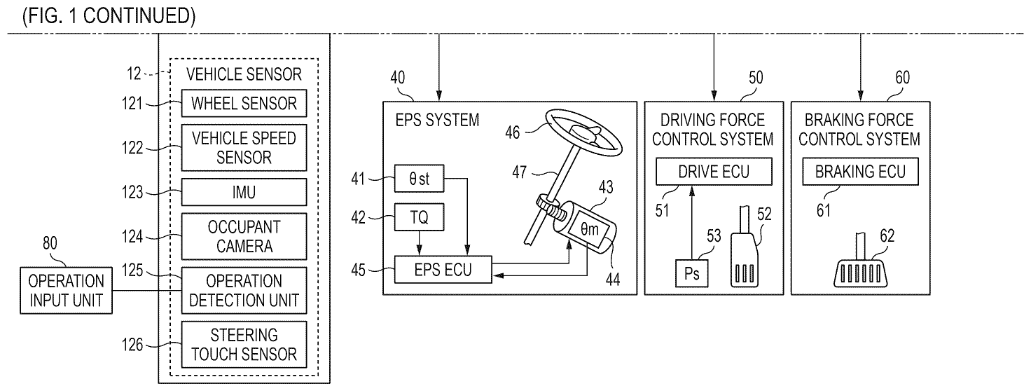

First, a vehicle according to the present embodiment will be described. FIG. 1 is a block diagram showing a configuration of a vehicle 1 equipped with a control device 30 according to the embodiment. The vehicle 1 is an automobile including a drive source (not shown) and wheels including drive wheels driven by power of the drive source and steerable steered wheels. As an example, the vehicle 1 can be a four-wheeled automobile having a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 is capable of automated driving and driving assistance, in which a driving operation is controlled to drive the vehicle 1 in an automated manner. The automated driving defined here refers to a system in which a system of the vehicle performs all driving operations such as recognizing or monitoring a travel environment and surrounding situations, as well as starting, accelerating and decelerating, steering, and stopping. The driving assistance is a system of the vehicle that performs a part of driving operations such as starting, accelerating and decelerating, steering, and stopping, and is, for example, a lane keep assist system (LKAS). In the embodiment described below, for example, driving assistance such as steering of a steering wheel for maintaining a travel lane is performed.

The vehicle 1 includes a sensor group 10, a navigation device 20, the control device 30, an electric power steering (EPS) system 40, a driving force control system 50, a braking force control system 60, a communication unit 70, and an operation input unit 80.

The sensor group 10 includes an external sensor 11 that acquires information related to surroundings of the vehicle 1, and a vehicle sensor 12 that acquires information related to the vehicle 1. Information (in other words, detection values) acquired by each sensor in the sensor group 10 is output to the control device 30.

The external sensor 11 includes, for example, a camera 111, a sonar 112, and a radar 113. The camera 111 is a digital camera that images the surroundings of the vehicle 1 including the vehicle 1 and outputs image data of an obtained peripheral image to the control device 30. In the present embodiment, since the vehicle 1 is capable of automated driving and automatic parking, the vehicle 1 has a front camera 111a, a rear camera 111b, a left side camera 111c, and a right side camera 111d in order to acquire peripheral images in all directions of the vehicle 1. The camera 111 does not need to include all of the cameras 111a to 111d, and may include at least a camera capable of performing driving assistance or the like.

The front camera 111a is provided, for example, at an upper portion of a windshield in a passenger compartment or a front bumper, and images a front region of the vehicle 1. The rear camera 111b is provided, for example, at a rear bumper, and images a rear region of the vehicle 1. The left side camera 111c is provided, for example, at a left side mirror, and images a left side region of the vehicle 1. The right side camera 111d is provided, for example, at a right side mirror, and images a right side region of the vehicle 1. As each of the cameras 111a to 111d, for example, a digital camera using an imaging element such as a charge coupled device (CCD) or a complementary metal oxide semiconductor (CMOS) can be adopted. In the following description, the front camera 111a, the rear camera 111b, the left side camera 111c, and the right side camera 11d will be simply referred to as a “camera 111” unless these cameras are particularly distinguished from one another.

The sonar 112 emits sound waves to a periphery of the vehicle 1 (for example, a front, a rear, and lateral sides of the vehicle 1), and receives reflected sounds from an object present in the periphery of the vehicle 1, thereby detecting a distance to the object, a direction of the object, and the like. The detected information is transmitted to the control device 30 at a predetermined cycle. The radar 113 emits radio waves to the periphery of the vehicle 1 including the front of the vehicle 1, and receives reflected waves from an object present in the periphery of the vehicle 1, thereby detecting a distance to the object, a direction of the object, and the like. The detected information is transmitted to the control device 30 at a predetermined cycle. The radar 113 may be, for example, a millimeter wave radar.

The external sensor 11 may include light detection and ranging (LiDAR) instead of or in addition to the sonar 112 and the radar 113. In this case, the LiDAR emits laser light to the periphery of the vehicle 1 including the front of the vehicle 1, and receives reflected light from an object present in the periphery of the vehicle 1, thereby detecting a distance to the object, a direction of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels of the wheels of the vehicle 1. As an example, the wheel sensor 121 detects a rotation angle of each of the left rear wheel and the right rear wheel. The wheel sensor 121 may be, for example, an angle sensor or a displacement sensor.

The vehicle speed sensor 122 detects a vehicle speed, which is a travel speed of the vehicle 1 (in other words, a movement speed of a vehicle body). For example, the vehicle speed sensor 122 detects the vehicle speed based on the number of revolutions of a countershaft (not shown) in the vehicle 1.

The inertial measurement unit 123 detects angular velocities of the vehicle 1 in a pitch direction, a roll direction, and a yaw direction, and acceleration of the vehicle 1 in a front-rear direction, a left-right direction, and an upper-lower direction. The vehicle sensor 12 may include, instead of the inertial measurement unit 123, an acceleration sensor that detects acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained vehicle interior image to the control device 30. For example, the occupant camera 124 can be a “driver monitor camera” that is provided to be able to image a head of a driver sitting in a driver seat of the vehicle 1 from the front (in other words, to image a face). Similarly to the camera 111, a digital camera using an imaging element such as a CCD or a CMOS can be adopted as the occupant camera 124. In the present embodiment, image data of a vehicle interior image obtained by the occupant camera 124 imaging the interior of the vehicle is information that can specify an orientation of a line of sight of the driver.

The operation detection unit 125 detects an operation performed using the operation input unit 80 that is provided to be operable by occupants including the driver. In the present embodiment, the operation input unit 80 includes, for example, an operation switch (not shown) that receives an operation to switch between on (in other words, operated) and off (in other words, not operated) of a driving assistance function such as the LKAS described above. In this case, the operation detection unit 125 can detect an operation of turning on and off the driving assistance function.

The steering touch sensor 126 detects whether a steering wheel 46 of the vehicle 1 is appropriately gripped. For example, the steering touch sensor 126 is implemented by a capacitance sensor or the like. In this case, the capacitance sensor is provided at a portion where the driver touches the steering wheel 46 when the steering wheel 46 is appropriately gripped. The steering wheel 46 is an example of a “steering device” according to the present disclosure.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The GNSS receiver 21 specifies the current position of the vehicle 1 (for example, a latitude and longitude of a point where the vehicle 1 is located) based on signals received from GNSS satellites. For example, the navigation device 20 may acquire a detection result of the vehicle sensor 12 (for example, the wheel sensor 121 or the vehicle speed sensor 122) via the control device 30, and may specify or complement the current position of the vehicle 1 based on an inertial navigation system (INS) using a detection value of the vehicle sensor 12.

The touch panel 22 functions as an input device that receives input of various types of information to the control device 30 and as a display device controlled by the control device 30. The touch panel 22 is implemented by combining a display device such as a liquid crystal display or an organic light emitting diode (OLED) with a pointing device (for example, touch pad). The speaker 23 is configured to output sound to an occupant (for example, a driver) of the vehicle 1.

For example, the navigation device 20 searches for a route from a current position of the vehicle 1 to a destination set by the driver using the touch panel 22 by referring to the map information database 24. Then, the navigation device 20 performs route guidance using the touch panel 22 and the speaker 23 based on the route searched for. The navigation device 20 may cause the touch panel 22 to perform a predetermined display according to an instruction from the control device 30. A specific display will be described later. Further, the navigation device 20 may output, to the control device 30, predetermined information such as information indicating a specified current position of the vehicle 1 or information indicating an operation received via the touch panel 22.

The control device 30 is a computer that includes, for example, a processor for performing various calculations, a storage unit having a non-transitory storage medium for storing various kinds of information, and an input and output unit that controls an input and output of data between an inside and outside of the control device 30 (none of which are shown), and executes overall control of the vehicle 1. For example, the control device 30 is implemented by one electronic control unit (ECU) or by a plurality of ECUs working in cooperation with each other. Since the control device 30 performs the driving assistance such as controlling the vehicle on behalf of the driver, and the control device 30 can also be called a control device in a so-called advanced driving assistance system (ADAS ECU). A specific configuration and a specific example of control of the control device 30 will be described later, and thus descriptions thereof are omitted here.

The EPS system 40 includes a steering angle sensor 41, a torque sensor 42, an EPS motor 43, a resolver 44, and an EPS ECU 45.

The steering angle sensor 41 detects a steering angle (actual steering angle) Ost of the steering wheel 46, and outputs information indicating the detected steering angle Ost to the EPS ECU 45. The torque sensor 42 detects a steering torque TQ, which is a torque applied to the steering wheel 46 of the vehicle 1, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle Om of the EPS motor 43 and outputs information indicating the detected rotation angle Om to the EPS ECU 45. The EPS motor 43 is an example of an “actuator” according to the present disclosure.

The EPS ECU 45 is a computer that includes, for example, a processor for performing various calculations, a storage unit including a non-transitory storage medium for storing various kinds of information, and an input and output unit that controls an input and output of data between an inside and outside of the EPS ECU 45 (none of which are shown), and controls the EPS system 40 (for example, the EPS motor 43), and is implemented by one or more ECUs. The EPS ECU 45 controls the EPS system 40 (for example, the EPS motor 43) based on the steering angle Ost detected by the steering angle sensor 41, the steering torque TQ detected by the torque sensor 42, the rotation angle Om detected by the resolver 44, and the like. For example, when controlling steering of the steering wheel 46 in an automated manner, the EPS ECU 45 performs feedback control (for example, PID control) such that the actual steering angle follows a target steering angle (that is, an instructed steering angle) of the steering wheel 46. For example, when the driver operates the steering wheel 46, the EPS ECU 45 executes steering assist control to increase a steering torque of the driver. The EPS ECU 45 may control the EPS system 40 according to an instruction from the control device 30.

The EPS system 40 (for example, the EPS ECU 45) outputs, to the control device 30, information indicating the steering angle Ost detected by the steering angle sensor 41, the steering torque TQ detected by the torque sensor 42, the rotation angle Om detected by the resolver 44, and the like. Further, the EPS system 40 (for example, the EPS ECU 45) outputs information indicating a steering angle velocity ω of the steering wheel 46 to the control device 30. The steering angle velocity ω is obtained by, for example, differentiating the steering angle Ost with respect to time.

The driving force control system 50 includes a drive ECU 51, and is configured to control a driving force of the vehicle 1. The drive ECU 51 is a computer that includes, for example, a processor that performs various calculations, a storage unit having a non-transitory storage medium that stores various kinds of information, and an input and output unit that controls an input and output of data between an inside and outside of the drive ECU 51 (none of which are shown), and controls the driving force control system 50, and is implemented by one or more ECUs. For example, the drive ECU 51 controls the driving force output from the drive source of the vehicle 1 based on an amount of operation of an accelerator pedal 52 provided in the vehicle 1 and a detection value of a shift position sensor 53 that detects a shift position Ps of a shift device (for example, a shift lever or a shift switch) (not shown). As described above, the drive source is an internal combustion engine or a motor, and the drive ECU 51 controls an output of the internal combustion engine or the motor based on the amount of operation of the accelerator pedal 52 and the shift position Ps. The drive ECU 51 can also control the driving force control system 50 (for example, a drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit having a non-transitory storage medium that stores various kinds of information, and an input and output unit that controls an input and output of data between an inside and outside of the braking ECU 61 (none of which are shown), and controls the braking force control system 60, and is implemented by one or more ECUs. For example, the braking ECU 61 controls a braking force of the vehicle 1 by controlling a brake device (not shown) provided in the vehicle 1 based on an operation of the brake pedal 62 provided on the vehicle 1. Here, the brake device includes, for example, a brake caliper, a cylinder that transmits hydraulic pressure to the brake caliper, and an electric motor that generates hydraulic pressure in the cylinder. The braking ECU 61 controls the electric motor of the brake device such that a braking force corresponding to an operation of the brake pedal 62 is generated. The braking ECU 61 can also control the braking force control system 60 according to an instruction from the control device 30.

The communication unit 70 is a communication interface that communicates with an external device 2 under an instruction of control executed by the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be adopted for communication between the vehicle 1 and the external device 2.

### Configuration of Control Device

Next, the control device 30 will be described in detail. For example, the control device 30 executes various programs stored in the storage unit of the control device 30. In the present embodiment, the control device 30 can execute steering control over the steering wheel 46 in an automated manner when executing the above-described driving assistance. For example, when the driving assistance function such as the LKAS is turned on, the control device 30 executes the steering control over the steering wheel 46 according to a behavior of the vehicle 1 in an automated manner. In addition to the steering control over the steering wheel 46, the control device 30 can execute steering assist control for increasing the steering torque (that is, torque assist) when the driver operates the steering wheel 46.

On the other hand, when an abnormality occurs in the control device 30 or the EPS system 40 due to some cause (for example, a malfunction), an unintended steering state may occur in both the driver and the control device 30. That is, there is a possibility that the driver cannot perform steering as intended because steering assist by the EPS system 40 cannot be obtained or a steering operation against the intention of the driver is performed. As for the control device 30, although the driving assistance is executed according to the behavior of the vehicle 1, there is a possibility that an intended operation cannot be executed. In the present embodiment, a steering state of the vehicle 1 is determined by determining whether the steering state is intended by the driver and determining whether the steering state is intended by the control device 30.

Specifically, the control device 30 executes, as an example of a program recorded in the storage unit, a program of steering state determination processing for determining whether a steering state of the vehicle 1 is intended when start of execution of the driving assistance is detected via an operation of an operation switch or the like in the operation input unit 80. The control device 30 includes an acquisition unit 31, a determination unit 32, a control unit 33, and a display control unit 34 as functional units that are implemented by executing the program. In the following, processing described as being executed by the acquisition unit 31, the determination unit 32, the control unit 33, and the display control unit 34 is processing implemented by the control device 30.

The acquisition unit 31 acquires the steering torque TQ applied to the steering wheel 46, the steering angle velocity ω applied to the steering wheel 46, and a steering angle deviation Qd that is a difference between an instructed steering angle Qref by the control device 30 and the actual steering angle Ost of the steering wheel 46. Specifically, the acquisition unit 31 acquires the steering torque TQ based on a detection value of the torque sensor 42. The acquisition unit 31 acquires the steering angle velocity ω by time-differentiating the steering angle Ost based on a detection value of the steering angle sensor 41. The acquisition unit 31 also acquires the steering angle deviation Qd that is a deviation between the instructed steering angle Qref that is the target steering angle of a steering angle of the steering wheel 46 and the actual steering angle Ost that is an actual steering angle of the steering wheel 46.

The instructed steering angle Qref can be determined based on, for example, a travel state of the vehicle 1 and a target trajectory of the vehicle 1. The travel state of the vehicle 1 is, for example, a current travel state of the vehicle 1 based on data detected by the external sensor 11 such as the camera 111, the vehicle speed sensor 122, the inertial measurement unit 123, and the like. The target trajectory is a target trace line of the vehicle 1 determined based on the travel state of the vehicle 1, that is, a target trajectory. The actual steering angle Ost is acquired based on a detection value of the steering angle sensor 41. The acquisition unit 31 obtains the steering angle deviation Qd based on a difference between the instructed steering angle Qref and the actual steering angle Ost acquired in this manner.

When the steering wheel 46 is being steered by the control device 30 (that is, when driving assistance such as LKAS is being executed), the determination unit 32 determines whether the steering wheel 46 is in a steering state intended by the driver or in a steering state intended by the control device 30 based on the steering torque TQ, the steering angle velocity ω ω, and the steering angle deviation Qd acquired using the function of the acquisition unit 31.

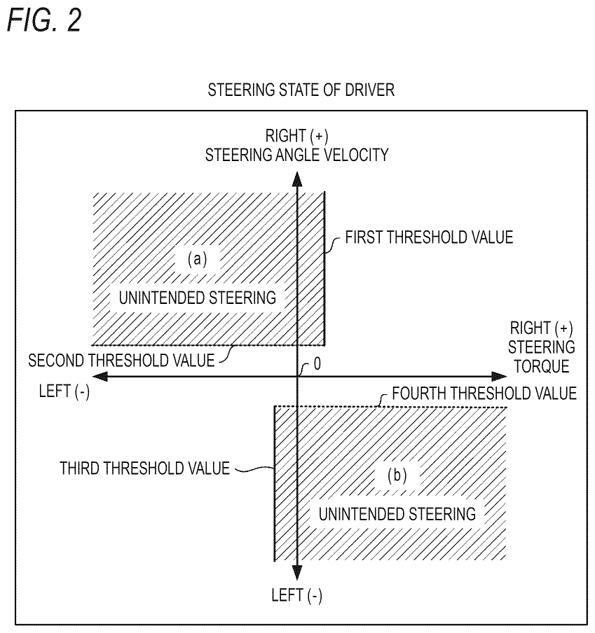

The steering state intended by the driver refers to a state in which, in a state in which steering by the control device 30 is possible, when the driver applies a steering force to the steering wheel 46, steering can be performed to a degree that does not cause discomfort or an uncomfortable sensation. In other words, the steering state can be defined as a state in which a response of the steering wheel 46 to the steering of the driver (i.e., input) is appropriate. For example, the steering angle velocity ω and the steering torque TQ can be assumed as parameters that give the driver the feeling of discomfort or the uncomfortable sensation. FIG. 2 is a diagram showing a steering state of the driver, in which a vertical axis represents the steering angle velocity ω and a horizontal axis represents the steering torque TQ, and a threshold value is set for each parameter. The determination unit 32 determines the steering state of the driver depending on whether each parameter is equal to or greater than the threshold value. In the example shown in FIG. 2, on either the vertical axis or the horizontal axis, a positive direction indicates a steering direction “right”, and a negative direction indicates a steering direction “left”.

More specifically, when the driver steers, for example, in a right direction as one steering direction, (a) if the steering torque TQ in the right direction is less than a first threshold value and the steering angle velocity ω in the right direction is equal to or greater than a second threshold value, or (b) if the steering torque TQ in the right direction is equal to or greater than a third threshold value that is smaller than the first threshold value and the steering angle velocity ω in the right direction is less than a fourth threshold value that is smaller than the second threshold value, the determination unit 32 determines that the vehicle is in a first anti-steering state that is not a steering state intended by the driver (hereinafter, also referred to as a “first anti-steering state”). In the example shown in FIG. 2, the two hatched regions (a) and (b) are regions of the first anti-steering state, and the determination unit 32 determines that a steering state is the first anti-steering state when the steering state of the driver is in either region (a) or (b). The region other than the hatched region may be referred to as a steering state intended by the driver. The right direction described here is an example of “one direction of clockwise and counterclockwise directions” in the present disclosure.

Next, a situation in which the above-described first anti-steering state in (a) and (b) may occur will be described. Specifically, for example, in a state in which a function of the LKAS is turned on, in a situation in which the driver lightly puts his or her hand on the steering wheel 46 without substantially generating the steering torque TQ, it is possible to assume a case in which steering not intended by the driver occurs from a host lane (namely, a lane on which the vehicle 1 is traveling) toward an oncoming lane (an oncoming lane on a right side) due to a failure of the control device 30 or the EPS system 40. In such a case, the driver grips the steering wheel 46, but the steering wheel 46 is not steered. However, since the steering wheel 46 is rotating to the right direction, the steering angle velocity ω is generated in the right direction, and the unintended steering state (a) may occur in which no steering torque TQ is generated by the driver.

As another example of the first anti-steering state, a state may be assumed in which the driver determines that the function of the driving assistance performed by the control device 30 is not necessary, but the steering by the driving assistance is intervening. For example, it is assumed that, in a state in which the function of the LKAS is turned on, while the driver is traveling on the host lane on a left side, the driver may move into an oncoming lane to avoid a preceding vehicle (or an obstacle or the like) stopped on a road shoulder, and then return to the host lane. In such a case, the driver steers the steering wheel 46 in the right direction when the driver enters the oncoming lane. At this time, the function of the LKAS operates to maintain the vehicle 1 in a travel lane when the vehicle 1 attempts to enter the oncoming lane. That is, the control device 30 steers the steering wheel 46 to a left direction. At this time, an unintended steering state may occur in which the steering torque of the driver is equal to or greater than a threshold value but the steering angle velocity ω is less than a threshold value. That is, an event may occur in which the steering by the control device 30 becomes dominant over the steering by the driver.

Thus, the “steering state intended by the driver” can be defined based on the steering torque and the steering angle velocity.

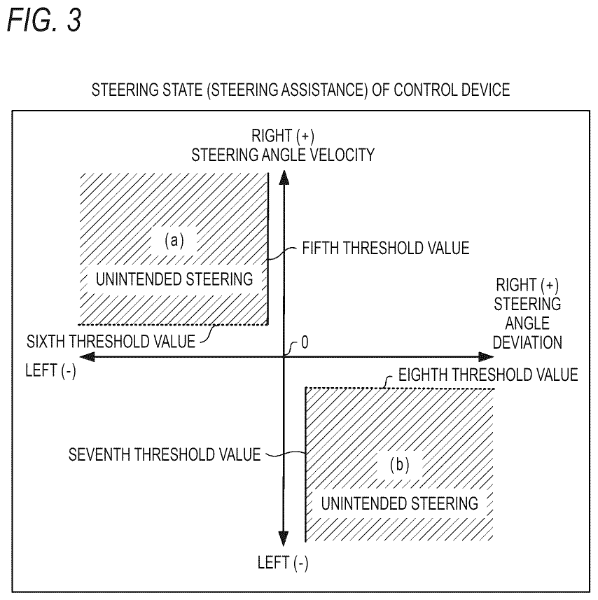

The steering state intended by the control device 30 refers to a state in which, in a state in which the driver is able to steer, when the control device 30 steers the steering wheel 46 so that a target trajectory is reached, there is almost no difference between the actual steering angle Ost with respect to the instructed steering angle Qref (that is, the steering angle deviation Qd). In other words, the steering state can be defined as a state in which the actual steering angle Ost of the steering wheel 46 is rotating in a direction that matches the instructed steering angle Qref of the control device 30. FIG. 3 is a diagram showing a steering state of the control device 30, in which a vertical axis represents the steering angle velocity ω and a horizontal axis represents the steering angle deviation Qd, and a threshold value is set for each parameter. The determination unit 32 determines the steering state of the control device 30 depending on whether each parameter is equal to or greater than the threshold value. In the example shown in FIG. 3, on either the vertical axis or the horizontal axis, a positive direction indicates a steering direction “right”, and a negative direction indicates a steering direction “left”.

More specifically, when the driver steers in the right direction as one steering direction, (c) if the steering angle deviation Qd in the right direction is less than a fifth threshold value and the steering angle velocity ω in the right direction is equal to or greater than a sixth threshold value, or (d) if the steering angle deviation Qd in the right direction is equal to or greater than a seventh threshold value that is larger than the fifth threshold value and the steering angle velocity ω in the right direction is less than an eighth threshold value that is smaller than the sixth threshold value, the determination unit 32 determines that the vehicle is in a second anti-steering state that is not a steering state intended by the control device 30 (hereinafter, also referred to as a “second anti-steering state”). In the example shown in FIG. 3, the two hatched regions (c) and (d) are regions of the second anti-steering state, and the determination unit 32 determines that a steering state is the second anti-steering state when the steering state of the control device 30 is in either region (c) or (d). The region other than the hatched region may be referred to as a steering state intended by the control device 30.

Next, a situation in which the above-described second anti-steering state in (c) and (d) may occur will be described. Specifically, for example, in a state in which a function of the LKAS is turned on, it is possible to assume a case in which steering not intended by the control device 30 occurs from a host lane toward an oncoming lane (an oncoming lane on the right side) due to a failure of the control device 30 or the EPS system 40. In such a case, since the steering wheel 46 is rotating to the right direction, the steering angle velocity ω is generated in the right direction, the actual steering angle Ost increases in the right direction with respect to the instructed steering angle Qref for maintaining the traveling in the host lane, which may result in an unintended steering state (c) in which the steering angle deviation Qd is equal to or greater than a threshold value.

As another example of the second anti-steering state, for example, it is assumed that, in a state in which the function of the LKAS is turned on, while the driver is traveling on the host lane on the left side, the driver may move into an oncoming lane to avoid a preceding vehicle (or an obstacle or the like) stopped on a road shoulder, and then return to the host lane. In such a case, the driver steers the steering wheel 46 in the right direction when the driver enters the oncoming lane. At this time, the control device 30 operates the function of the LKAS to maintain the vehicle 1 in a travel lane when the vehicle 1 attempts to enter the oncoming lane. That is, the control device 30 steers the steering wheel 46 to the left direction. At this time, if the steering torque of the driver is equal to or greater than a predetermined value, an unintended steering state may occur in which the actual steering angle Ost increases with respect to the instructed steering angle Qref, causing the steering angle deviation Qd to be equal to or greater than the threshold value. That is, the control device 30 is in a state in which a steering force of the driver is large and a lane of the vehicle 1 cannot be maintained.

Thus, the “steering state intended by the control device 30” can be defined based on the steering angle deviation Qd and the steering angle velocity ω.

The threshold values for determining the steering state of the driver and the steering state of the control device 30 are not limited to the values shown in FIGS. 2 and 3, and may be determined in advance by, for example, the manufacturer of the vehicle 1.

If it is determined that the steering state is the first anti-steering state and the second anti-steering state, the determination unit 32 determines that the vehicle 1 is not in the intended steering state. That is, if the steering state of the driver is the state (a) or (b), and the steering state of the control device 30 is the state (c) or (d), the determination unit 32 determines that the vehicle 1 is not in the intended steering state. Accordingly, it is possible to determine that the vehicle 1 is not in the intended steering state based on operating states of both the steering state of the driver and the steering state of the control device 30.

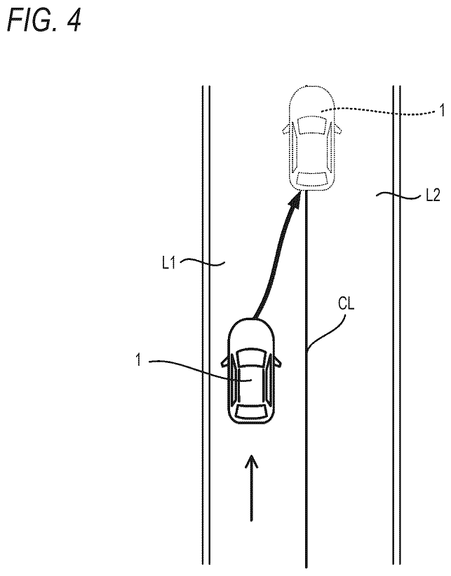

Here, an example in which the vehicle 1 is not in the intended steering state will be described using an example in which it is determined that the above-described states (a) and (c) are satisfied. FIG. 4 is an example in which, in a state in which the function of the LKAS is turned on as an example of the driving assistance, the vehicle 1 travels while maintaining a lane in a host lane L1, and unintended steering of the vehicle 1 occurs from the host lane L1 toward a center line CL and an oncoming lane L2 due to, for example, a failure of the EPS system 40. In such a situation, the driver grips the steering wheel 46 but does not steer the steering wheel 46. At this time, since the steering wheel 46 is rotated in the right direction, the steering angle velocity ω is generated in the right direction, but the steering torque TQ is not generated by the driver, resulting in a state (a). On the other hand, the steering state according to the control device 30 is a state (c) in which the steering wheel 46 is rotated in the right direction, so that the steering angle velocity ω is generated in the right direction, and the actual steering angle Ost increases in the right direction with respect to the instructed steering angle Qref for maintaining traveling in the host lane L1, and the steering angle deviation Qd is equal to or greater than the threshold value. In such a case, the first anti-steering state and the second anti-steering state, which are not the steering states intended by the driver and the control device 30, are satisfied, and an event occurs in which the vehicle 1 is not in the intended steering state.

If it is determined that the steering state is the first anti-steering state and the second anti-steering state, when it is determined that the vehicle 1 is in the first anti-steering state and the second anti-steering state for a predetermined time or longer, the determination unit 32 preferably determines that the steering state of the vehicle 1 is not the intended steering state. This is because, for example, there is a possibility that the first anti-steering state and the second anti-steering state may occur instantaneously due to an external disturbance (for example, road surface reaction force) or the like. That is, this is to eliminate noise that may occur instantaneously. The predetermined time is set to, for example, 20 ms to 200 ms.

If it is determined that the vehicle 1 is not the intended steering state using the function of the determination unit 32 described above, the control unit 33 ends steering control of performing an operation of the steering wheel 46 in an automated manner. The control unit 33 executes the steering control when the function of driving assistance (or automated driving) is turned on. That is, when the driving assistance function is turned on, the control unit 33 executes steering control via the EPS ECU 45 according to a behavior of the vehicle 1. In addition to the steering control, the control unit 33 can execute drive control and braking control over the vehicle 1 via the drive ECU 51 and the braking ECU 61. That is, the drive control, the braking control, and the steering control are executed to make the vehicle 1 travel along the target trajectory or stabilize the behavior. On the other hand, if it is determined that the vehicle 1 is not the intended steering state using the function of the determination unit 32 described above, the control unit 33 ends the steering control. That is, the driving assistance being executed is ended. Since the vehicle 1 is not the intended steering state, the driving assistance is ended and the driver takes the initiative of steering.

The control unit 33 can execute steering assist control to increase (i.e., assist) the steering torque applied to the steering wheel 46 by the driver. On the other hand, if the determination unit 32 determines that the vehicle 1 is not in the intended steering state, an amount of the steering assist for the steering of the driver is reduced. This is because it is possible to achieve a steering state in which an intention of the driver is further reflected by reducing the amount of the steering assist. The amount of steering assist to be reduced may be determined in advance by, for example, the manufacturer of the vehicle 1.

The display control unit 34 displays a control state of the vehicle 1 by the control unit 33 on a display unit such as the touch panel 22. For example, if it is determined that the vehicle 1 is not in the intended steering state and the control unit 33 ends the driving assistance or reduces the amount of the steering assist, the display control unit 34 displays the information on the display unit such as the touch panel 22. The driver who views the display can easily grasp the control state of the vehicle 1, and can easily perform steering according to the control state. That is, steerability of the steering wheel 46 can be improved compared with a case where the information is not available.

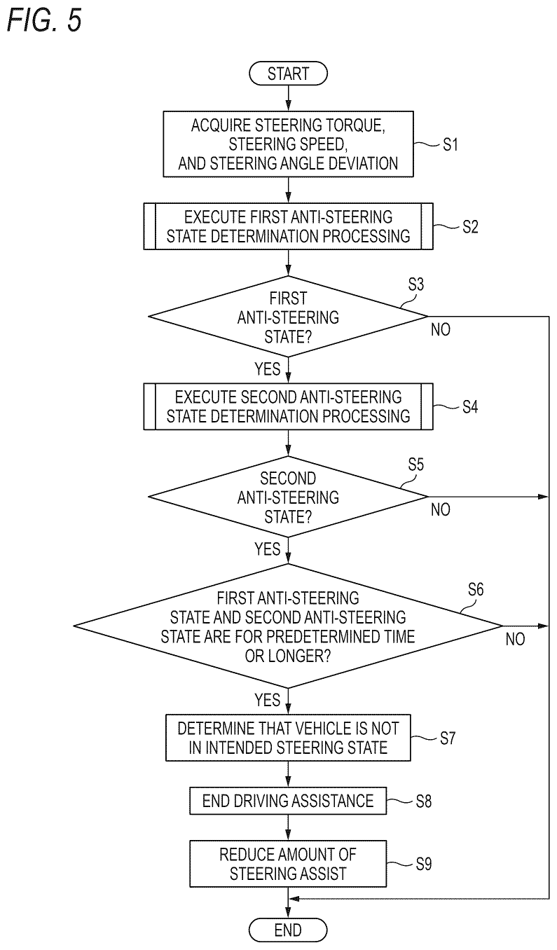

Processing Executed by Control Device Next, an example of the steering state determination processing executed by the control device 30 will be described with reference to a flowchart. FIG. 5 is a flowchart showing an example of the processing, and the processing is repeatedly executed at predetermined short time intervals, for example, when the function of the driving assistance is on.

The control device 30 first acquires the steering torque TQ, the steering angle velocity ω, and the steering angle deviation Qd (step S1). That is, the control device 30 acquires each parameter value for determining a steering state of the vehicle 1 based on each detection value or the like in the sensor group 10 using the function of the acquisition unit 31.

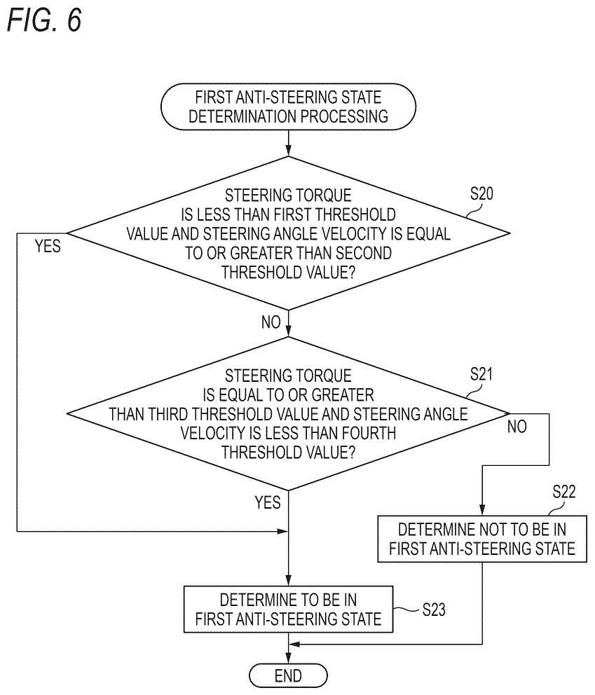

Next, the control device 30 executes first anti-steering state determination processing, using the function of the determination unit 32, to determine whether the vehicle is in the first anti-steering state (step S2). FIG. 6 is a flowchart (subroutine) showing an example of the first anti-steering state determination processing. The first anti-steering state determination processing is processing of determining a steering state of the driver.

The control device 30 first determines whether the steering torque is less than the first threshold value and the steering angle velocity is equal to or greater than the second threshold value (step S20). If it is determined in step S20 that at least one of the conditions of the steering torque and the steering angle velocity is not satisfied (No in step S20), the control device 30 advances the processing to step S21.

In step S21, the control device 30 determines whether the steering torque is equal to or greater than the third threshold value and the steering angle velocity is less than the fourth threshold value. If it is determined in step S21 that at least one of the conditions of the steering torque and the steering angle velocity is not satisfied (No in step S21), the control device 30 determines that the state is not the first anti-steering state (step S22).

On the other hand, if it is determined in step S20 that the steering torque is less than the first threshold value and the steering angle velocity is equal to or greater than the second threshold value (Yes in step S20), or if it is determined in step S21 that the steering torque is equal to or greater than the third threshold value and the steering angle velocity is less than the fourth threshold value (Yes in step S21), the control device 30 determines that the state is the first anti-steering state (step S23). The first anti-steering state determination processing shown in FIG. 6 ends. A processing order of step S20 and step S21 may be reversed.

Returning to FIG. 5, the control device 30 determines whether the state is the first anti-steering state (step S3). That is, the control device 30 determines whether the steering state is the first anti-steering state based on a result of the first anti-steering state determination processing in step S2 (specifically, the processing in FIG. 6) described above, using the function of the determination unit 32.

In step S3, if it is determined that the state is not the first anti-steering state (No in step S3), the control device 30 temporarily ends the processing of the flowchart shown in FIG. 5. In contrast, if it is determined in step S3 that the steering state is the first anti-steering state (Yes in step S3), the control device 30 advances the processing to step S4.

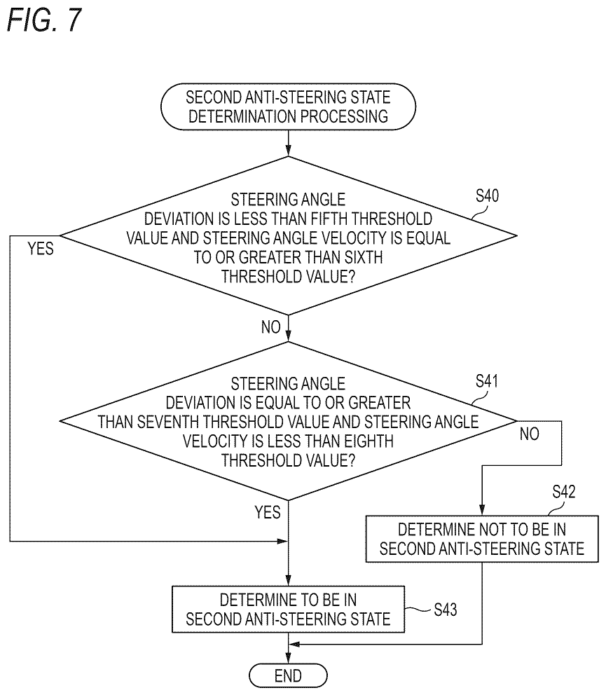

In step S4, the control device 30 executes second anti-steering state determination processing, using the function of the determination unit 32, to determine whether the vehicle is in the second anti-steering state. FIG. 7 is a flowchart (subroutine) showing an example of the second anti-steering state determination processing. The second anti-steering state determination processing is processing of determining a steering state of the control device 30.

The control device 30 first determines whether the steering angle deviation is less than the fifth threshold value and the steering angle velocity is equal to or greater than the sixth threshold value (step S40). If it is determined in step S40 that at least one of the conditions of the steering angle deviation and the steering angle velocity is not satisfied (No in step S40), the control device 30 advances the processing to step S41.

In step S41, the control device 30 determines whether the steering angle deviation is equal to or greater than the seventh threshold value and the steering angle velocity is less than the eighth threshold value. If it is determined in step S41 that at least one of the conditions of the steering angle deviation and the steering angle velocity is not satisfied (No in step S41), the control device 30 determines that the state is not the second anti-steering state (step S42).

On the other hand, if it is determined in step S40 that the steering angle deviation is less than the fifth threshold value and the steering angle velocity is equal to or greater than the sixth threshold value (Yes in step S40), or if it is determined in step S41 that the steering angle deviation is equal to or greater than the seventh threshold value and the steering angle velocity is less than the eighth threshold value (Yes in step S41), the control device 30 determines that the state is the second anti-steering state (step S43). The second anti-steering state determination processing shown in FIG. 7 ends. A processing order of step S40 and step S41 may be reversed.

Returning to FIG. 5, the control device 30 determines whether the state is the second anti-steering state (step S5). That is, the control device 30 determines whether the steering state is the second anti-steering state based on a result of the second anti-steering state determination processing in step S4 (specifically, the processing in FIG. 7) described above, using the function of the determination unit 32.

In step S5, if it is determined that the state is not the second anti-steering state (No in step S5), the control device 30 temporarily ends the processing of the flowchart shown in FIG. 5. In contrast, if it is determined in step S5 that the steering state is the second anti-steering state (Yes in step S5), the control device 30 advances the processing to step S6.

Since the determination processing of each of the first anti-steering state and the second anti-steering state can be executed independently, an order of step S2 and step S3 and step S4 and step S5 may be reversed.

In step S6, the control device 30 determines whether the first anti-steering state and the second anti-steering state continues for a predetermined time or longer, using the function of the determination unit 32. This processing is processing for eliminating noise such as an external disturbance as described above. In step S6, if it is determined that the predetermined time does not elapse since it is determined that the state is the first anti-steering state and the second anti-steering state (No in step S6), the control device 30 temporarily ends the processing of the flowchart shown in FIG. 5.

On the other hand, if it is determined in step S6 that the predetermined time elapses after it is determined that the state is the first anti-steering state and the second anti-steering state (Yes in step S6), the control device 30 determines that the vehicle 1 is not in the intended steering state using the function of the determination unit 32 (step S7). That is, it is confirmed that the steering state is not the one intended by the driver and the control device 30.

Then, the control device 30 ends the driving assistance (step S8). That is, the control device 30 ends the driving assistance that is being executed using the function of the control unit 33. Since it is determined that the vehicle 1 is not in the intended steering state, an operation of the driver is prioritized.

The control device 30 reduces an amount of the steering assist (step S9). That is, the control device 30 reduces the amount of the steering assist that increases a steering torque of the driver using the function of the control unit 33. Since it is determined that the vehicle 1 is not in the intended steering state, an operation of the driver is further reflected by reducing the amount of the steering assist.

An order of the step S8 and the step S9 may be reversed, or only one of the step S8 and the step S9 may be executed.

As described above, in the present embodiment, when the driving assistance is executed by the control device 30, it is determined whether the steering state is intended by the driver or intended by the control device 30 based on the steering torque, the steering angle velocity, and the steering angle deviation. That is, as described above, the control device 30 determines whether the steering state is the first anti-steering state based on the steering torque TQ and the steering angle velocity ω, and determines whether the steering state is the second anti-steering state based on the steering angle deviation and the steering angle velocity. If it is determined that the steering state is the first anti-steering state and the second anti-steering state, the control device 30 determines that the steering state of the vehicle 1 is not the intended steering state. Accordingly, it is possible to determine the steering state of the vehicle 1 more accurately than when the steering state of the vehicle 1 is determined based only on the steering state of the driver, for example. By executing such processing, the control device 30 can improve a safety of traffic and contribute to development of a sustainable transportation system.

In the present embodiment, the control device 30 determines that the vehicle 1 is not in the intended steering state if it is determined that the vehicle 1 is in the first anti-steering state and the second anti-steering state for a predetermined time or longer. Accordingly, for example, when the first anti-steering state and the second anti-steering state are instantaneously caused due to an external disturbance caused by a road surface reaction force or the like, it is possible to exclude the determination that the vehicle 1 is not in the intended steering state, and it is possible to more accurately determine the steering state.

In the present embodiment, if it is determined that the vehicle 1 is not in the intended steering state, the control device 30 ends the steering of the driving assistance performed by the control device 30. Accordingly, even if an event occurs in which the vehicle 1 is not in the intended steering state, by ending the driving assistance, the steering (in other words, accurate steering) according to the intention of the driver can be performed due to a steering state led by the driver.

In the present embodiment, if it is determined that the vehicle 1 is not in the intended steering state, the control device 30 reduces the amount of steering assist for steering by the driver. Accordingly, even if an event occurs in which the vehicle 1 is not in the intended steering state, the steering of the driver is further reflected in the behavior of the vehicle 1 by reducing the amount of the steering assist, and as a result, the steering according to an intention of the driver (in other words, accurate steering) becomes possible.

### OTHER EMBODIMENTS

Next, another embodiment will be described. In the above-described embodiment, if it is determined in step S6 that the vehicle 1 is in the first anti-steering state and the second anti-steering state for the predetermined time or longer, it is determined that the vehicle 1 is not in the intended steering state. On the other hand, this processing only needs to be able to eliminate instantaneous noise due to a road surface reaction force or the like as described above, and may be changed to the following configuration.

For example, the control device 30 may set a predetermined time for each of the first anti-steering state and the second anti-steering state to eliminate instantaneous noise due to the above-described road surface reaction force or the like. In this case, the control device 30 may relax a condition of the predetermined time determined in step S6. Specifically, the control device 30 determines that the vehicle 1 is not in the intended steering state when determining that the vehicle 1 is in the first anti-steering state for a first predetermined time or longer and determining that the vehicle 1 is in the second anti-steering state for a second predetermined time or longer, using the function of the determination unit 32. In this case, the predetermined time for determining that the vehicle 1 is not in the steering state in step S6 may be shortened, or a condition for the predetermined time may be omitted (that is, step S6 may be skipped).

Thus, in each of the determination of the first anti-steering state and the determination of the second anti-steering state (in other words, determination of the steering state of the driver and determination of the steering state of the control device 30), processing of eliminating the instantaneous noise due to the road surface reaction force or the like is performed, and thus it is possible to more accurately determine the steering state of the vehicle 1.

### Others

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

For example, in the above-described embodiment, two parameters for determining the first anti-steering state and the second anti-steering state are provided. However, the number of parameters may be two or more as long as the steering state of the driver and the steering state of the control device 30 can be determined.

In the above-described embodiment, the steering angle deviation and the steering angle velocity of the steering wheel 46 are used as parameters. However, the parameters may include parameters related to a steering angle of the wheel in addition to or in place of the parameters related to the steering angle of the steering wheel 46.

The predetermined time set in step S6 described above may be set to different values for a predetermined time for ending the driving assistance in step S8 and a predetermined time for reducing the amount of the steering assist in step S9. At this time, the predetermined time for reducing the amount of the steering assist is set to be shorter than the predetermined time for determining an end of the driving assistance. Accordingly, when the steering state is not as intended, the amount of steering assist is reduced to reduce the behavior of the vehicle 1, and when the steering state is still not as intended even after the amount of steering assist is reduced, the driving assistance is ended. By setting in this manner, for example, even if it is determined that the steering state is not an unintended steering state due to noise caused by a road surface input or the like during traveling, the control can be executed (transitioned) in stages.

In the above-described embodiment, the driving assistance is ended in step S8, but the driving assistance may be continued in a state where a control amount of the driving assistance is reduced without ending the driving assistance. Although the amount of steering assist is reduced in step S9, the steering assist may be ended.

The control method described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements in the embodiment described above are shown in parentheses, the present disclosure is not limited thereto.
(1) A control device (control device 30) configured to control a vehicle (vehicle 1) that allows for steering a steering device (steering wheel 46) by a driver and steering the steering device by the control device, the control device including:
an acquisition unit (acquisition unit 31) configured to acquire a steering torque, a steering angle velocity, and a steering angle deviation, which is a difference between an instructed steering angle by the control device and an actual steering angle of the steering device, in the steering device; and
a determination unit (determination unit 32) configured to determine, when the steering device is steered by the control device, whether a steering state is a steering state intended by the driver or a steering state intended by the control device, based on the steering torque, the steering angle velocity, and the steering angle deviation.

According to (1), it is possible to determine whether the steering state is intended by the driver or intended by the control device, so that the steering state of the vehicle can be determined more accurately than, for example, when it is determined based only on the steering state of the driver.
(2) The control device according to (1), in which
when the steering torque in a steering direction, which is one direction of a clockwise direction and a counterclockwise direction, is less than a first threshold value and the steering angle velocity in the steering direction is equal to or greater than a second threshold value, or when the steering torque in the steering direction is equal to or greater than a third threshold value that is smaller than the first threshold value and the steering angle velocity in the steering direction is less than a fourth threshold value that is smaller than the second threshold value, the determination unit determines that a steering state is a first anti-steering state that is not a steering state intended by the driver,
when the steering angle deviation in the steering direction is less than a fifth threshold value and the steering angle velocity in the steering direction is equal to or greater than a sixth threshold value, or when the steering angle deviation in the steering direction is equal to or greater than a seventh threshold value that is greater than the fifth threshold value and the steering angle velocity in the steering direction is less than an eighth threshold value that is smaller than the sixth threshold value, the determination unit determines that a steering state is a second anti-steering state that is not a steering state intended by the control device, and
when the determination unit determines that the steering state is the first anti-steering state and the second anti-steering state, the determination unit determines that the vehicle is not in an intended steering state.

According to (2), by providing a plurality of parameters for determining the steering state and further providing threshold values for the plurality of parameters, it is possible to determine the steering state more accurately than in a case where, for example, one parameter is used to determine the steering state.
(3) The control device according to (2), in which
the determination unit determines that the vehicle is not in an intended steering state when the determination unit determines that the vehicle is in the first anti-steering state or the second anti-steering state for a predetermined time or longer.

According to (3), for example, when the first anti-steering state and the second anti-steering state are instantaneously caused due to an external disturbance caused by a road surface reaction force or the like, it is possible to exclude the determination that the vehicle is not in the intended steering state, and it is possible to more accurately determine the steering state.
(4) The control device according to (3), in which
the determination unit determines that the vehicle is not in the intended steering state when the determination unit determines that the steering state is the first anti-steering state for a first predetermined time or longer or when the determination unit determines that the steering state is the second anti-steering state for a second predetermined time or longer, and relaxes a condition for the predetermined time for determining that the vehicle is not in the intended steering state.

According to (4), in each of the determination of the first anti-steering state and the determination of the second anti-steering state, processing of eliminating noise caused by an external disturbance due to a road surface reaction force or the like is executed, and thus it is possible to more accurately determine the steering state of the vehicle.
(5) The control device according to (1), further including:
a control unit (control unit 33) configured to execute steering by the control device, in which
the control unit ends the steering by the control device when the determination unit determines that the vehicle is not in an intended steering state.

According to (5), even if an event occurs in which the vehicle is not in the intended steering state, by ending the driving assistance, the steering according to the intention of the driver can be performed due to a steering state led by the driver.
(6) The control device according to (1), further including:
a control unit configured to assist steering by the driver, in which
steering by the driver is steering assist for increasing the steering torque by an actuator (EPS motor 43), and
the control unit reduces an amount of the steering assist for the steering by the driver when the determination unit determines that the vehicle is not in an intended steering state.

According to (6), even if an event occurs in which the vehicle is not in the intended steering state, the steering of the driver is further reflected in the behavior of the vehicle by reducing the amount of the steering assist, and as a result, the steering according to an intention of the driver becomes possible.

1. A control device configured to control a vehicle that allows for steering a steering device by a driver and steering the steering device by the control device,
wherein the control device comprises circuitry configured to:
acquire a steering torque, a steering angle velocity, and a steering angle deviation which is a difference between an instructed steering angle by the control device and an actual steering angle of the steering device; and
determine, when the steering device is steered by the control device, whether a steering state is a steering state intended by the driver or a steering state intended by the control device, based on the steering torque, the steering angle velocity, and the steering angle deviation.

2. The control device according to claim 1, wherein
when the steering torque in a steering direction, which is one direction of a clockwise direction and a counterclockwise direction, is less than a first threshold value and the steering angle velocity in the steering direction is equal to or greater than a second threshold value, or when the steering torque in the steering direction is equal to or greater than a third threshold value that is smaller than the first threshold value and the steering angle velocity in the steering direction is less than a fourth threshold value that is smaller than the second threshold value, the circuitry determines that the steering state is a first anti-steering state that is not the steering state intended by the driver,
when the steering angle deviation in the steering direction is less than a fifth threshold value and the steering angle velocity in the steering direction is equal to or greater than a sixth threshold value, or when the steering angle deviation in the steering direction is equal to or greater than a seventh threshold value that is greater than the fifth threshold value and the steering angle velocity in the steering direction is less than an eighth threshold value that is smaller than the sixth threshold value, the circuitry determines that the steering state is a second anti-steering state that is not the steering state intended by the control device, and
when the circuitry determines that the steering state is the first anti-steering state and the second anti-steering state, the circuitry determines that the vehicle is not in an intended steering state.

3. The control device according to claim 2, wherein
the circuitry determines that the vehicle is not in the intended steering state, when determining that the vehicle is in the first anti-steering state or the second anti-steering state for a predetermined time or longer.

4. The control device according to claim 3, wherein
when determining that the steering state is the first anti-steering state for a first predetermined time or longer or when determining that the steering state is the second anti-steering state for a second predetermined time or longer, the circuitry determines that the vehicle is not in the intended steering state, and relaxes a condition for the predetermined time for determining that the vehicle is not in the intended steering state.

5. The control device according to claim 1, wherein the circuitry is further configured to:
execute steering by the control device; and
end the steering by the control device when determining that the vehicle is not in an intended steering state.

6. The control device according to claim 1, wherein
the circuitry is further configured to assist steering by the driver,
steering assist for increasing the steering torque by an actuator is applied to steering by the driver, and
the circuitry reduces an amount of the steering assist for the steering by the driver, when determining that the vehicle is not in an intended steering state.
